(19) United States
(12) Patent Application Publication
(10) Pub. No.: US 2021/0185805 A1
(43) Pub. Date: Jun. 17, 2021

(54) PRINTED WIRING BOARD, ELECTRONIC CIRCUIT, DETERMINING METHOD OF WIRING, AND PROGRAM

(71) Applicant: NEC Corporation, Minato-ku, Tokyo (JP)

(72) Inventor: Kazuhiro KASHIWAKURA, Tokyo (JP)

(73) Assignee: NEC Corporation, Minato-ku, Tokyo (JP)

(21) Appl. No.: 16/082,361

(22) PCT Filed: Mar. 14, 2017
(86) PCT No.: PCT/JP2017/010073

§ 371 Date: Sep. 5, 2018

(30) Foreign Application Priority Data
Mar. 18, 2016 (JP) 2016-56292

(51) Int. Cl. H05K 1/02; H05K 1/03; G06F 30/394

(52) U.S. Cl. CPC H05K 1/0298; H05K 1/024; H05K 1/0248; H05K 2201/0195; H05K 1/0306; G06F 30/394; H05K 1/0366

(57) ABSTRACT

A printed wiring board comprises: an insulation layer configured by a glass cloth in which fiber is woven, and a resin with which the glass cloth is impregnated; first wiring configured by a first line, a second line, and a third line; and second wiring configuring by a fourth line, a fifth line, and a sixth line, wherein a line length of the first line and a line length of the second line are equal to each other, a line length of the fifth line and a line length of the sixth line are equal to each other, a line length of the fourth line and the fifth line and a line length of the first line and the second line are equal to each other, and a line length of the first wiring and a line length of the second wiring are equal to each other.

### TECHNICAL FIELD

The present invention relates to a printed wiring board, an electronic circuit, a determining method of wiring, and a program.

### BACKGROUND ART

In general, a printed wiring board is formed by attaching copper foil, which is to be a transmission line, to an insulation layer. The insulation layer is formed by impregnating, with resin, a glass cloth made of fibers woven in both longitudinal and lateral directions. Therefore, the volume ratio of the fiber and the resin in the insulation layer is not even. Due to this, mutually opposing portions of the insulation layer have different permittivity from each other, depending on a position of the transmission line. This difference in permittivity affects a propagation delay of the transmission line formed on the printed wiring board.

Because a positive signal line and a negative signal line, which constitute a differential signal line, are located in different positions from each other, the permittivity is different in mutually opposing portions. This difference in permittivity causes a difference in propagation delay (differential skew) between a positive signal line and a negative signal line.

A differential signal requires that a positive signal and a negative signal are different in phase from each other by 180 degrees. However, if the differential skew is generated to reduce the phase difference between the positive signal and the negative signal, insertion loss will increase. For this reason, it is desirable not to cause any differential skew between a positive signal line and a negative signal line.

From this perspective, a technology to restrain a differential skew has been proposed.

For example, Patent Literature 1 (PTL1) discloses a technology to alleviate a differential skew, by setting a line width to be 75% to 95% of an interval between fibers woven in a glass cloth.

Patent Literature 2 (PTL2) discloses a technology to alleviate a differential skew by wiring the differential signal line in a form of a sine wave.

Patent Literature 3 (PTL3) discloses a technology to alleviate a differential skew by causing an interval between fibers to match with an interval between differential signal lines.

### CITATION LIST

### Patent Literature

[PTL1] Japanese Laid-Open Patent Application No. 2014-130860

[PTL2] Japanese Laid-Open Patent Application No. 2015-050924

[PTL3] WO2016/117320

### SUMMARY OF INVENTION

### Technical Problem

In the technology disclosed in PTL1, a line width is set to be 75% to 95% of an interval between fibers woven in a glass cloth. An interval between fibers is approximately 0.4 mm to 0.7 mm, in general. Therefore, this technology requires a line width of equal to or more than 0.3 mm. Generally, a line width used for a multilayer circuit board is approximately 0.1 mm; therefore, it is difficult to apply this technology, which requires a line width of equal to or more than 0.3 mm, to an actual product.

In addition, the technology disclosed in PTL2 arranges the lines in a form of a sine wave, and therefore requires a wider area than the line width. Therefore, it is difficult to wire the differential signal lines using this technology, in an area having a narrow wiring region, such as immediately below a Large Scale Integrated circuit (LSI). For example, it is difficult to wire a differential signal line with a line width of 0.1 mm using this technique, on a Ball Grid Array (BGA) terminal of 1 mm grid.

The technology disclosed in PTL3 causes an interval between fibers to match with an interval between differential signal lines. However, as explained above, an interval between fibers is approximately 0.4 mm to 0.7 mm, in general. Therefore, it is difficult to apply such technology in a wiring region, for example immediately below an LSI having a BGA terminal of 1 mm grid.

In view of the above situations, an objective of the present invention is to provide a printed wiring board including wiring having a small differential skew applicable to a narrow wiring region, and a manufacturing method thereof.

### Solution to Problem

To achieve the above-described object, a printed wiring board according to the present invention characterized by comprising: an insulation layer configured by a glass cloth in which fiber is woven, and a resin with which the glass cloth is impregnated;

first wiring configured by
a first line extending on an imaginary straight line that is parallel to the fiber woven in the glass cloth,
a second line extending on an imaginary straight line that is parallel to the first line, the second line being separate from the imaginary straight line on which the first line extends, by a distance resulting from adding ½ of an interval of the fiber to an integer multiple equal to 0 or more of the interval of the fiber, and
a third line connecting lines configuring the first line and the second line; and

second wiring configuring by
a fourth line extending on an imaginary straight line that is parallel to the first line,
a fifth line on an imaginary straight line that is parallel to the fourth line, the fifth line being separate from the imaginary straight line on which the fourth line extends, by a distance resulting from adding ½ of an interval of the fiber to an integer multiple equal to 0 or more of the interval of the fiber, and
a sixth line connecting lines configuring the fourth line and the fifth line, wherein

a total line length of the first line and a total line length of the second line are equal to each other,

a total line length of the fifth line and a total line length of the sixth line are equal to each other,

a total line length of the fourth line and the fifth line and a total line length of the first line and the second line are equal to each other, and

a line length of the first wiring and a line length of the second wiring are equal to each other.

### Advantageous Effect of Invention

The present invention enables a printed wiring board to include wiring having a small differential skew applicable to a narrow wiring region.

### BRIEF DESCRIPTION OF DRAWINGS

FIG. 1 is a plan view of a printed wiring board according to a first example embodiment of the present invention.

FIG. 2A is a sectional view taken along II-II of FIG. 1, and FIG. 2B is a sectional view taken along II′-II′ of FIG. 1. Note that hatching is not drawn in the sectional view, so that the figures are easy to view.

FIG. 3A is an enlarged view of the II-II section of FIG. 1, FIG. 3B, FIG. 3C, and FIG. 3D are graphs representing a volume ratio of fibers with respect to resin, in the sectional view of FIG. 3A.

FIG. 4 is a block diagram of a processor that executes a program to form a wiring pattern.

FIG. 5 is a flowchart of a determining method of a wiring pattern according to the first example embodiment of the present invention.

FIG. 6 is a flowchart of a calculation method of wiring of a selected line in FIG. 5.

FIG. 7 is a diagram for explaining a calculation method of a wiring pattern in a selected line.

FIG. 8 is a plan view of a printed wiring board according to a second example embodiment of the present invention.

FIG. 9 is a plan view of a printed wiring board according to a third example embodiment of the present invention.

FIG. 10 is a plan view of a printed wiring board according to a fourth example embodiment of the present invention.

FIG. 11 is a plan view of a printed wiring board according to a fifth example embodiment of the present invention.

FIG. 12 is a plan view of a printed wiring board according to a sixth example embodiment of the present invention.

FIG. 13 is a plan view of a printed wiring board according to a seventh example embodiment of the present invention.

FIG. 14 is a diagram for explaining a printed wiring board according to a modification example.

FIG. 15 is a plan view of a printed wiring board according to an exemplary embodiment of the present invention.

### EXAMPLE EMBODIMENT

The following describes a printed wiring board and a manufacturing method thereof according to example embodiments of the present invention, with reference to the drawings.

### First Example Embodiment

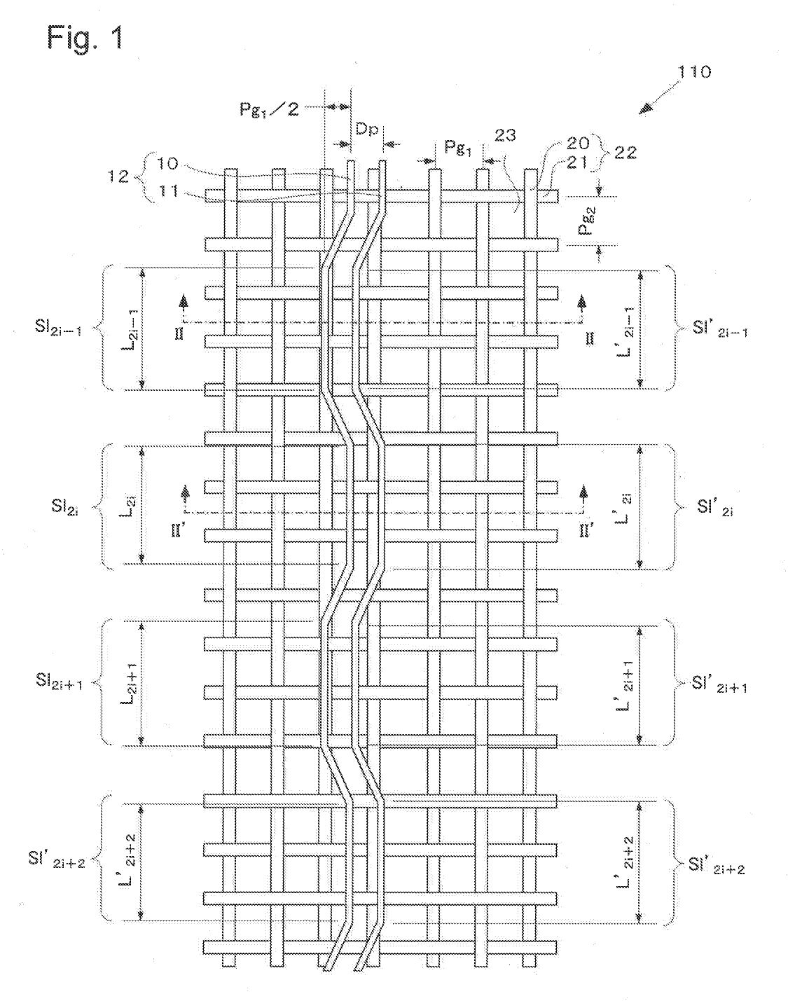

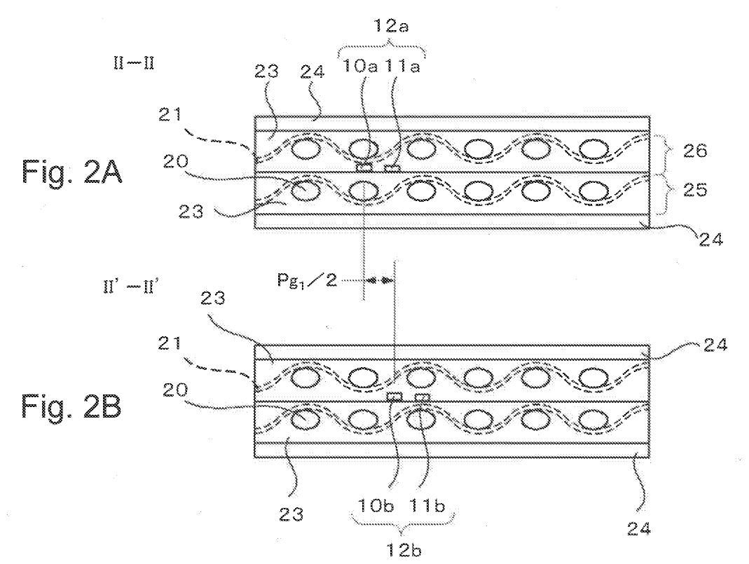

As illustrated in FIG. 1 and FIGS. 2A and 2B, a printed wiring board 110 according to the first example embodiment is configured by: insulation layers 25 and 26, formed by impregnating, with a resin 23, a glass cloth 22 made of fibers 20, 21 woven in both longitudinal and lateral directions; and copper foil and the like being a conductor, and is configured by a transmission line 12 wired between the insulation layers 25 and 26; and a ground layer 24 sandwiching the insulation layers 25 and 26. An interval of fibers 20 is set to be Pg₁. As follows, the interval of fibers 20 is referred to as a glass cloth interval.

As illustrated in FIGS. 2A and 2B, the fibers 20 configuring the insulation layers 25 and 26 are disposed parallel to each other.

As illustrated in FIG. 1, the transmission line 12 is configured by a positive signal line 10 and a negative signal line 11. Each of the positive signal line 10 and the negative signal line 11 is formed to have a line width of 0.1 to 0.2 mm. The positive signal line 10 and the negative signal line 11 are lines having an interval Dp therebetween and being parallel to each other. The relationship: the interval Dp<the glass cloth interval Pg₁ is satisfied.

The transmission line 12 is a winding line being repeatedly curved. The positive signal line 10 has: a line of a length L₂ᵢ₋₁ at a positive signal line section S1₂ᵢ₋₁ which is a straight portion parallel to the fiber 20; and a line of a line length L₂ᵢ at a positive signal line section S1₂ᵢ. The negative signal line 11 has: a line of a length L′₂ᵢ₋₁ at a negative signal line section S1′₂ᵢ₋₁ which is a straight portion parallel to the positive signal line section S1₂ᵢ₋₁; and a length of L′₂ᵢ at a negative signal line section S1′₂ᵢ. Note that “i” denotes arbitrary natural number. Note that the positive signal line section S1₂ᵢ₋₁ and the negative signal line section S1′₂ᵢ₋₁ each represent an odd-number line section, whereas the positive signal line section S1₂ᵢ and the negative signal line section S1′₂ᵢ each represent an even-numbered line section.

A straight line connects between the positive signal line section S1₂ᵢ₋₁ and the positive signal line section S1₂ᵢ. Similarly, a straight line connects between the negative signal line section S1′₂ᵢ₋₁ and the negative signal line section S1′₂ᵢ.

The odd-numbered positive signal line section S1₂ᵢ₋₁ extends along a same imaginary straight line, whereas the even-numbered positive signal line section S1₂ᵢ extends along a same imaginary straight line that is parallel to the positive signal line sections S1₂ᵢ₋₁. Similarly, the odd-numbered negative signal line section S1′₂ᵢ₋₁ extends along a same imaginary straight line, whereas the even-numbered negative signal line section S1′₂ᵢ extends along a same imaginary straight line that is parallel to the negative signal line section S1′₂ᵢ₋₁. An interval between the imaginary straight line along which the positive signal line section S1₂ᵢ₋₁ extends and the imaginary straight line along which the positive signal line section S1₂ᵢ extends is ½ of the glass cloth interval Pg₁. Similarly, the imaginary straight line along which the negative signal line section S1′₂ᵢ₋₁ extends and the imaginary straight line along which the negative signal line section S1′₂ᵢ extends is Pg₁/2.

As expressed in Equation 1, a total line length of the positive signal line sections S1₂ᵢ₋₁ and a total line length of the positive signal line sections S1₂ᵢ are equal to each other. In addition, a total line length of the negative signal line sections S1′₂ᵢ₋₁ and a total line length of the negative signal line sections S1′₂ᵢ are equal to each other. A total line length of the positive signal line section, that is, a total line length of the positive signal line section S1₂ᵢ₋₁ and the positive signal line section S1₂ᵢ is equal to a total line length of the negative signal line sections, that is, a total line length of the negative signal line section S1′₂ᵢ₋₁ and the negative signal line section S1′₂ᵢ. Note that, in Equation 1, “N₁” represents the number of the positive signal line sections S1₂ᵢ₋₁, “N₂” represents the number of the positive signal line section S1₂ᵢ, “N′₁” represents the number of the negative signal line section S1′₂ᵢ₋₁, and “N′₂” represents the number of the negative signal line section S1′₂ᵢ, and N=N₁+N₂ᵢ N′=N′₁+N′₂.

$${\sum }_{i = 1}^{{N}_{1}} {L}_{2 i - 1} = {\sum }_{i = 1}^{{N}_{2}} {L}_{2 i} \\ {\sum }_{i = 1}^{{N}_{1}^{′}} {L}_{2 i - 1}^{′} = {\sum }_{i = 1}^{{N}_{2}^{′}} {L}_{2 i}^{′} \\ {\sum }_{i = 1}^{{N}_{1}} {L}_{2 i - 1} + {\sum }_{i = 1}^{{N}_{2}} {L}_{2 i} = {\sum }_{i = 1}^{{N}_{1}^{′}} {L}_{2 i - 1}^{′} + {\sum }_{i = 1}^{{N}_{2}^{′}} {L}_{2 i}^{′} \qquad [ Math . 1 ]$$

In addition, an overall length of the positive signal line 10 and an overall length of the negative signal line 11 are equal to each other.

The following explains properties of the printed wiring board 110 having the above-described configuration.

As illustrated in FIG. 2A, in the positive signal line section S1₂ᵢ₋₁ of the positive signal line 10, a volume ratio of the fibers 20 with respect to the resin 23 is high in a vicinity of the positive signal line 10a (opposing regions). On the other hand, as illustrated in FIG. 2B, in the positive signal line section S1₂ᵢ, a volume ratio of the fibers 20 with respect to the resin 23 is low in a vicinity of the positive signal line 10b (opposing regions).

Here, both the positive signal line section S1₂ᵢ₋₁ and the positive signal line section S1₂ᵢ extend along an imaginary straight line that is parallel to the fiber 20. Therefore, in a vicinity of the positive signal line sections S1₁ to S_{2·N1-1} (opposing regions), volume ratios of the fibers 20 with respect to the resin 23 per unit distance are substantially equal to each other. Therefore, permittivity between each positive signal line section S1₁, S1ⱼ, . . . , S_{2·N1-1} and the ground layer 24 per unit distance is substantially equal to each other. Similarly, permittivity between each positive signal line section S1₂ᵢ S1₄, . . . , S_{2·N2} and the ground layer 24 per unit distance is substantially equal to each other.

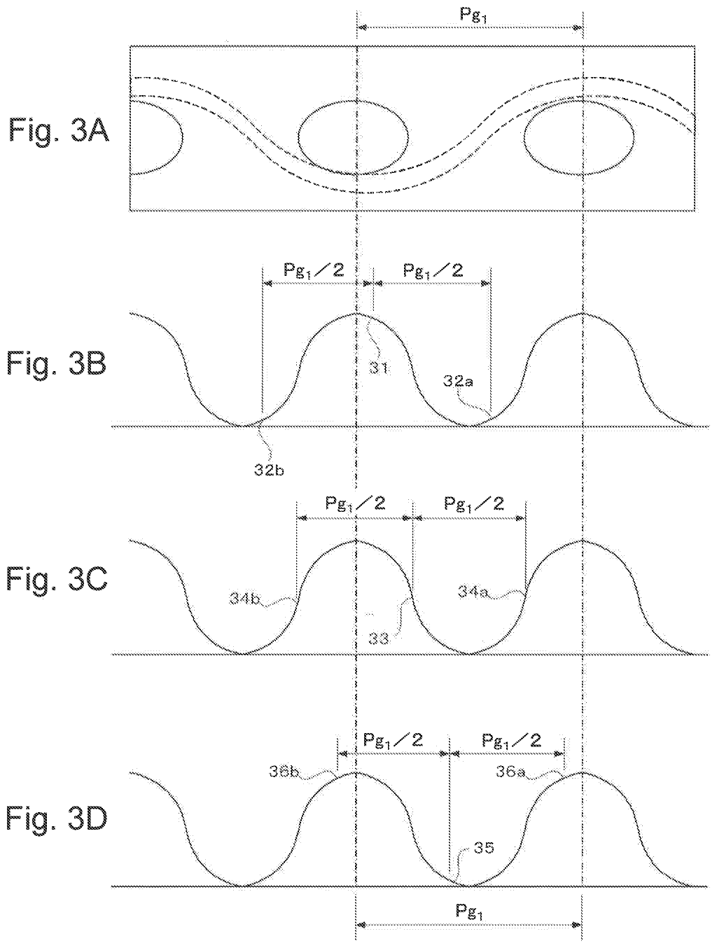

Here, as illustrated in FIG. 3A, the fiber 20 is thickest at the center position of the fiber, and thinner towards outside. Therefore, as illustrated in FIGS. 3B, 3C, and 3D, a volume ratio of the fiber 20 with respect to the resin 23 is in a form like a mountain that is laterally symmetrical, with its vertex being the center position of the fiber. In addition, the fiber 20 is woven at a glass cloth interval Pg₁. Therefore, a volume ratio of the fiber 20 with respect to the resin 23 in a direction perpendicular to the direction of the fiber 20 is repeated in the glass cloth interval Pg₁. Therefore, as illustrated in FIG. 3B, at positions 32a and 32b which are separate from a position 31 at which a volume ratio of the fiber 20 with respect to the resin 23 is high, by Pg₁/2 in a direction perpendicular to a direction to the fiber 20, a volume ratio of the fiber 20 with respect to the resin 23 is low. As illustrated in FIG. 3C, at positions 34a and 34b which are separate by Pg₁/2 from a position 33 at which a volume ratio of the fiber 20 with respect to the resin 23 is medium, a volume ratio of the fiber 20 with respect to the resin 23 is also medium. As illustrated in FIG. 3D, at positions 36a and 36b which are separate by Pg₁/2 from a position 35 at which a volume ratio of the fiber 20 with respect to the resin 23 is low, a volume ratio of the fiber 20 with respect to the resin 23 is high. That is, at a position separate by Pg₁/2 from positions at which a volume ratio of the fiber 20 with respect to the resin 23 is high, a volume ratio of the fiber 20 is low; whereas at a position separate by Pg₁/2 from positions at which a volume ratio of the fiber 20 with respect to the resin 23 is low, a volume ratio of the fiber 20 is high.

Permittivity is higher as a volume ratio of the fiber 20 is higher. Therefore, as permittivity is higher between the odd-numbered positive signal line section S1₂ᵢ₋₁ and the ground layer 24, permittivity is lower between the even-numbered positive signal line section S1₂ᵢ and the ground layer 24. As permittivity is higher, the propagation delay is larger. Therefore, as a propagation delay for unit distance is larger in the odd-numbered positive signal line section S1₂ᵢ₋₁, a propagation delay for unit distance is smaller in the even-numbered positive signal line section S1₂ᵢ.

Here, because a total line length of the positive signal line section S1₂ᵢ₋₁ and a total line length of the positive signal line section S1₂ᵢ are equal to each other, a propagation delay for the entire positive signal line 10 is equalized. Therefore, a possible range of a propagation delay for unit distance for the entire positive signal line 10 is smaller than a possible range of a propagation delay for unit distance for when the positive signal line is wired freely.

On the other hand, the negative signal line sections S1′₂ᵢ₋₁, and the negative signal line sections S1′₂ᵢ are respectively extend along an imaginary straight line that is parallel to the fiber 20. Therefore, a volume ratio of the fiber 20 with respect to the resin 23 for unit distance in a vicinity of each negative signal line section S1′₂ᵢ₋₁ is substantially equal. Consequently, permittivity between the negative signal line section S1′₂ᵢ₋₁ and the ground layer 24 for unit distance is substantially equal to each other. Similarly, permittivity per distance between each negative signal line section S1′₂ᵢ and the ground layer 24 is substantially equal to one another.

Similarly to the positive signal line sections S1₂ᵢ₋₁, S1₂ᵢ, as a propagation delay for unit distance is larger in the odd-numbered negative signal line section S1′₂ᵢ₋₁, a propagation delay for unit distance is smaller in the even-numbered negative signal line section S1′₂ᵢ.

Because a total line length of the negative signal line section S1′₂ᵢ₋₁ and a total line length of the negative signal line section S1′₂ᵢ are equal to each other, a propagation delay for the entire negative signal line 11 is equalized. Therefore, a possible range of a propagation delay for unit distance for the entire negative signal line 11 is smaller than a possible range of a propagation delay for unit distance when the negative signal line is wired freely.

In addition, because the positive signal line 10 and the negative signal line 11 are lines configuring the transmission line 12 sandwiched between the insulation layers 25 and 26, the possible range of a propagation delay for unit distance is equal between the positive signal line 10 and the negative signal line 11.

Furthermore, because a total line length of the positive signal line sections S1₂ᵢ₋₁, S1₂ᵢ and a total line length of the negative signal line sections S1′₂ᵢ₋₁, S1′₂ᵢ are equal to each other, the maximum value of a differential skew in the transmission line 12 is smaller than the maximum value of a differential skew when the positive signal line 10 and the negative signal line 11 are wired freely. As a result, an effect that a difference in permittivity between the resin 23 and the fiber 20 in the transmission line 12 has on a propagation delay is smaller than in case where the positive signal line 10 and the negative signal line 11 are wired freely.

In the printed wiring board 110, a signal generator, which transmits a differential signal, is connected to an end of the transmission line 12; and such a component as a semiconductor integrated circuit, which receives a differential signal, is connected to the other end, for use.

A voltage having a sine wave is applied by the signal generator to the transmission line 12. Here, a phase difference between voltages applied to the positive signal line 10 and the negative signal line 11 by the signal generator is 180 degrees.

In this configuration, as described above, an effect that a difference in permittivity between the resin 23 and the fiber 20 has on a propagation delay is small, due to the property of the printed wiring board 110. Therefore, an effect of an insertion loss on the transmission line 12 from the signal generator to the component is also small, and therefore, the semiconductor integrated circuit can be operated normally.

(Manufacturing Method of Printed Wiring Board)

The following explains a manufacturing method of a printed wiring board 110 having the above-described configuration.

A glass cloth 22 is prepared by weaving fibers 20 and 21 at a certain pitch.

The glass cloth 22 is impregnated with a resin 23, thereby manufacturing insulation layers 25 and 26. The resin 23 is composed of an insulating material, such as an epoxy resin, a polyimide resin, or polyester resin, for example.

Next, a wiring pattern of the printed wiring board 110 is determined. In accordance with the determined wiring pattern, a transmission line 12 is formed by metal foil, such as copper foil, of a conductor on one surface of the insulation layer 25. In a forming process of the transmission line 12, various types of method of forming wiring patterns may be adopted, such as a subtractive process and an additive process. Finally, on the surface of the insulation layer 25, on which the transmission line 12 is formed, the insulation layer 26 is overlapped, and a pair of ground layers 24, made of metal foil such as copper foil, is placed in such a manner to sandwich the insulation layer 25, 26, and pressed, thereby manufacturing the printed wiring board 110.

Determination of the wiring pattern may be conducted by executing a computer program. The following explains a determining method of a wiring pattern with reference to the drawings.

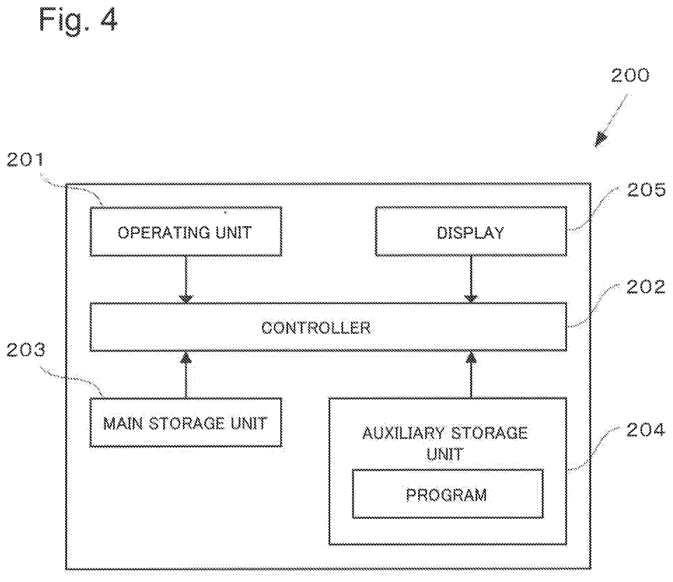

As illustrated in FIG. 4, a processor 200 operable to execute a computer program is configured by: an operating unit 201 such as a keyboard and a mouse; a controller 202 that processes a program, a main storage unit 203 that accumulates data used in executing a program; an auxiliary storage unit 204 that accumulates data such as a program; and a display 205 that displays a result of a program, and the like.

The operating unit 201 transmits data input from the keyboard, the mouse, or the like, to the controller 202.

The controller 202 is configured by a Central Processing Unit (CPU), and the like, and executes a program by using data received from the operating unit 201, the main storage unit 203, or the auxiliary storage unit 204. In addition, the controller 202, where necessary, transmits data during program execution, to the main storage unit 203 or the auxiliary storage unit 204. During execution of a program, the controller 202 also requests data from the main storage unit 203 or the auxiliary storage unit 204, where necessary.

The main storage unit 203 accumulates data received from the controller 202. In addition, the main storage unit 203 transmits the accumulated data upon request by the controller 202.

The auxiliary storage unit 204 accumulates data received from the controller 202. In addition, the auxiliary storage unit 204 transmits the accumulated data such as a program, upon request by the controller 202.

The display 205 receives data from the controller 202, and displays the data.

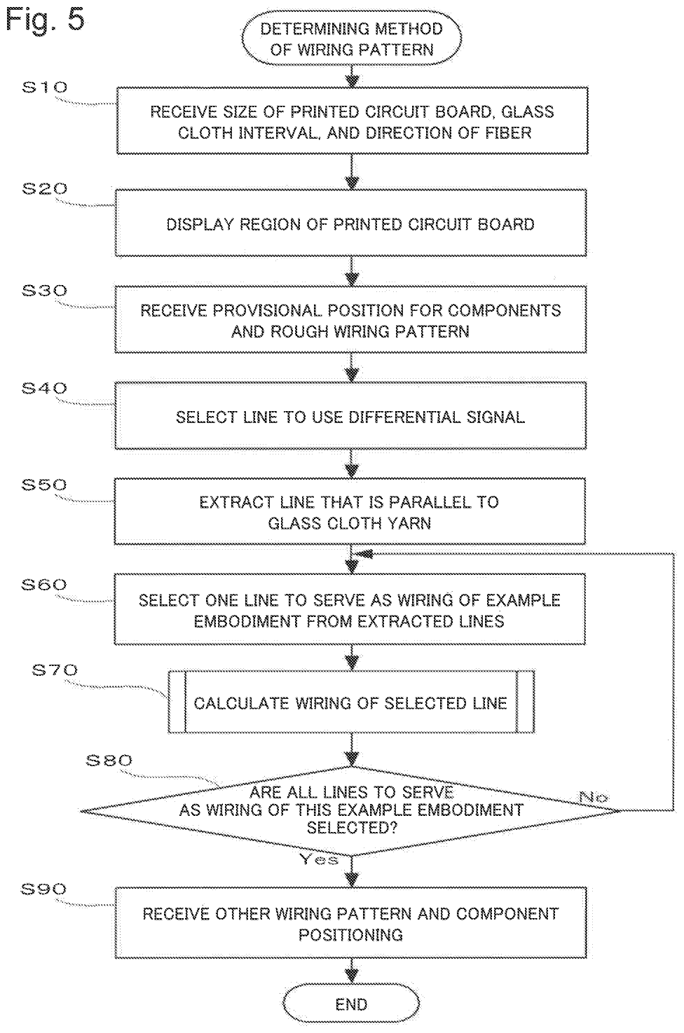

In a determining method of a wiring pattern, first, a size of a targeted printed wiring board 110, intervals Pg₁ and Pg₂ of the fibers 20 and 21 of the insulation layers 25 and 26, and a direction of the fiber 20 are received from the operating unit 201 (S10), as illustrated in FIG. 5. Next, in accordance with the size of the printed wiring board 110 which has been received, the controller 202 displays, on the display 205, a region for the printed wiring board 110 (S20). In accordance with the region for the printed wiring board 110 displayed on the display 205, a provisional position for the components to be mounted, and a rough wiring pattern are received from the operating unit 201 (S30). Subsequently, the operating unit 201 selects a differential signal line from the rough wiring pattern (S40).

The controller 202 extracts a line parallel to the fiber 20 woven into the glass cloth, from the selected differential signal line, and displays the extracted line on the display 205 (S50). Note that a partial section of the line corresponds to this, the corresponding section is extracted as the line.

Next, a designer selects a line to which the wiring according to this example embodiment is to be applied, from the lines displayed on the display 205, and designates the selected line through the operating unit 201 (S60). The controller 202 calculates the wiring of the selected line, using in a later-explained method, and displays the calculated wiring on the display 205 (S70). Whether all the lines to which the wiring method according to the present example embodiment is applied are selected is confirmed on the display 205 (S80). If there is any line left unselected, selection of a line from the extracted lines is conducted again, the selected line is input through the operating unit 201, and the wiring is determined (S60, S70). If there is no line left unselected, the lines for which the wiring pattern is not determined and the positioning of the components are input through the operating unit 201 (S90). In this way, the entire wiring pattern is determined.

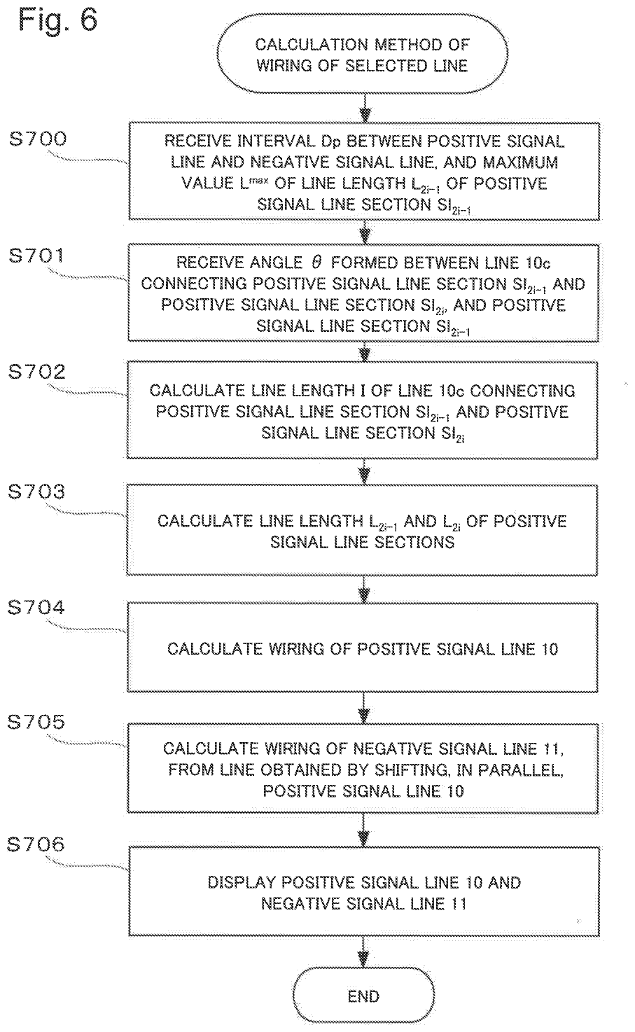

The following describes details of a method to calculate (S70) wiring with respect to the selected line, with reference to FIG. 6.

First, an interval Dp between the positive signal line and the negative signal line, and the maximum value L^{max} of the line length L₂ᵢ₋₁ of the positive signal line section S1₂ᵢ₋₁ are input through the operating unit 20 (S700).

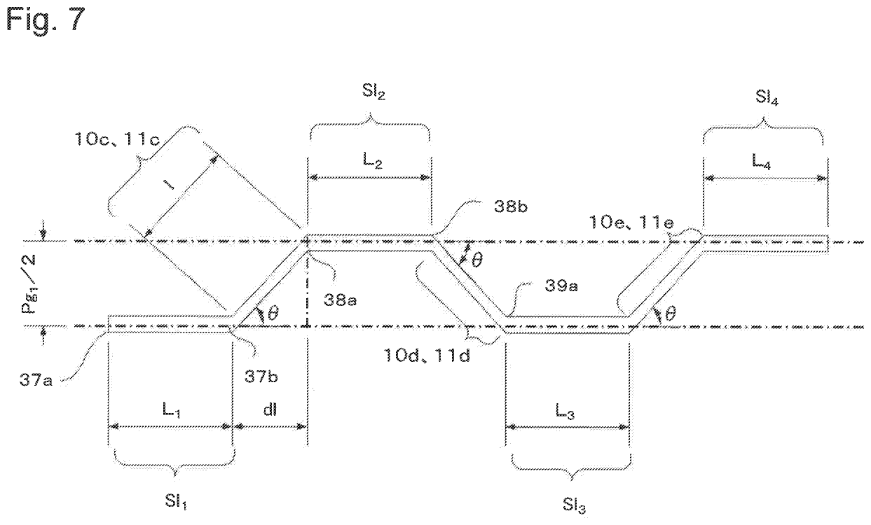

Next, through the operating unit 201, an angle θ formed between the line 10c connecting the positive signal line section S1₂ᵢ₋₁ and the positive signal line section S1₂ᵢ, and the imaginary straight line to position the positive signal line section S1₂ᵢ₋₁ are received (S701). Note that 0°<θ<90° holds, as illustrated in FIG. 7.

Because an interval between the imaginary straight lines to position the positive signal line section S1₂ᵢ₋₁ and the positive signal line section S1₂ᵢ are Pg₁/2, the controller 202 calculates a line length 1 of the line 10c and a length dl of a component of the line 10c in a direction of the positive signal line section S1₂ᵢ₋₁, based on the input angle θ and from Equation 2 (S702).

$$1 = \frac{P {g}_{1}}{2 sin θ} \\ d 1 = \frac{P {g}_{1}}{2 tan θ} \qquad [ Math . 2 ]$$

The controller 202 calculates the line length L₂ᵢ₋₁ of the positive signal line section S1₂ᵢ₋₁, the line length L₂ᵢ of the positive signal line section S1₂ᵢ, and the number N of the positive signal line section S1ᵢ, so as to satisfy Equation 3, based on the length dl of the component of the line 10c in the direction of the positive signal line section S1₂ᵢ₋₁ having been calculated (S703). Here, as illustrated in Equation 3, line lengths L₂ᵢ₋₁, L₂ᵢ of the positive signal line sections S1₂ᵢ₋₁ and S1₂ᵢ are assumed to be equal, in the calculation. Note that Lₐₙ represents a length of a selected line.

$${L}_{all} = ( N - 1 ) d 1 + {\sum }_{i = 1}^{{N}_{1}} {L}_{2 i - 1} + {\sum }_{i = 1}^{{N}_{2}} {L}_{2 i} \\ {\sum }_{i = 1}^{{N}_{1}} {L}_{2 i - 1} = {\sum }_{i = 1}^{{N}_{2}} {L}_{2 i} \\ N = {N}_{1} + {N}_{2} \\ {L}_{2 i - 1} = {L}_{2 i} \\ {L}_{2 i} ≦ {L}^{max} \\ {L}_{2 i - 1} ≦ {L}^{max} \qquad [ Math . 3 ]$$

Next, the controller 202 calculates a positive signal line section S1₁ of a line length L₁, which is parallel to the fiber 20. Here, as illustrated in FIG. 7, the positive signal line section S1₁ is a line whose one end 37a is positioned at one end of the selected line, and the other end 37b thereof is positioned on the other end of the selected line. Next, a line 10c is calculated, whose one end is one end 37b of the positive signal line section S1₁, and which forms an angle 180°−θ with the positive signal line section S1₁, and has a length 1. Subsequently, the positive signal line section S1₂ is calculated, whose one end is one end 38a of the connected line 10c, and which is parallel to the positive signal line section S1₁ and has a line length L₂. Here, an angle between the positive signal line section S1₂ and the line 10c is 180°−θ. A line 10d of a length 1, whose one end is the other end 38b of the positive signal line section S1₂ᵢ and which forms an angle 180°−θ with the positive signal line section S1₂ is calculated. Here, the other end 39a of the line 10d positions on the imaginary straight line that is extended from the positive signal line section S1₁. Subsequently, a positive signal line section S1ⱼ of a line length L₃, whose one end is one end 39a of the line 10d, and which is parallel to the positive signal line section S1₁ is calculated. This process is repeated till reaching the positive signal section S1_{N}, thereby calculating wiring for the positive signal line 10 (S704).

The controller 202 calculates wiring for the negative signal line 11, which is shifted towards a direction perpendicular from the direction of the transmission line by an interval Dp between the positive signal line 10 and the negative signal line 11, from the positive signal line 10 for which the wiring has been determined (S705).

Finally, the controller 202 displays the calculated positive signal line 10 and the negative signal line 11, on the display 205 (S706).

In the wiring calculated in the above-described method, the negative signal line 11 is a line which results from moving the positive signal line 10 parallelly. Therefore, the wiring satisfies Equation 4, and an overall length of the positive signal line 10 and an overall length of the negative signal line 11 are equal to each other. Consequently, this will be a configuration of the printed wiring board 110.

$${\sum }_{i = 1}^{{N}_{1}^{′}} {L}_{2 i - 1}^{′} = {\sum }_{i = 1}^{{N}_{2}^{′}} {L}_{2 i}^{′} \\ {\sum }_{i = 1}^{{N}_{1}} {L}_{2 i - 1} + {\sum }_{i = 1}^{{N}_{2}} {L}_{2 i} = {\sum }_{i = 1}^{{N}_{1}^{′}} {L}_{2 i - 1}^{′} + {\sum }_{i = 1}^{{N}_{2}^{′}} {L}_{2 i}^{′} \qquad [ Math . 4 ]$$

### Second Example Embodiment

The first example embodiment is an example in which the wiring region has no limitation to be located. However, the invention according to the present application can be applied to such wiring positioned in a narrow wiring region immediately below the LSI having a BGA terminal or the like. The following explains the second example embodiment in which the invention according to the present invention is applied to the wiring positioned in a narrow wiring region.

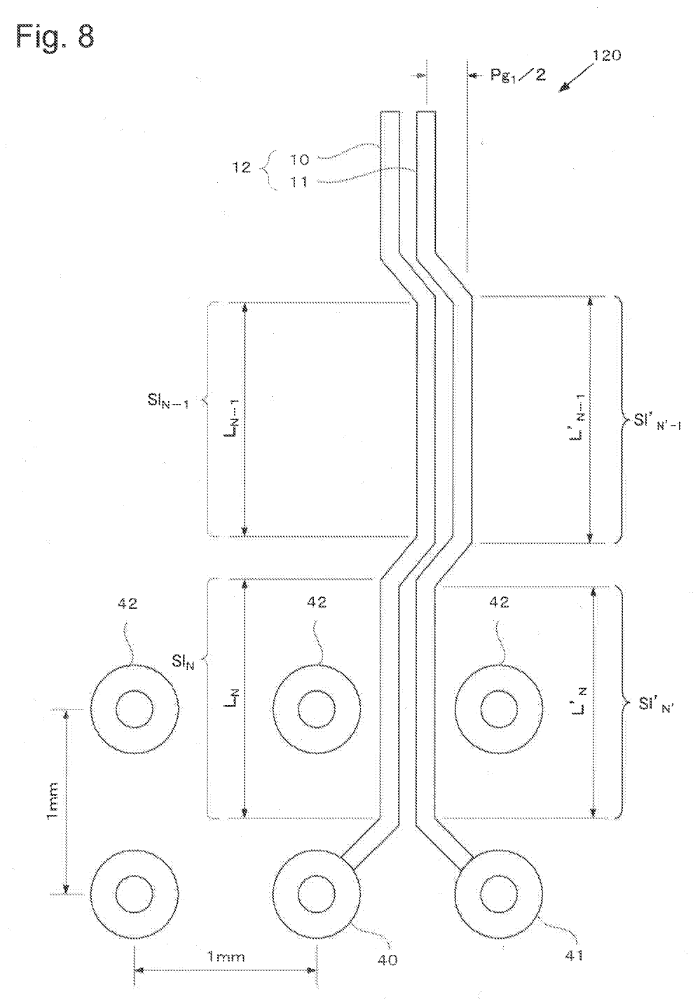

As illustrated in FIG. 8, the transmission line 12 of the printed wiring board 120 according to the second example embodiment is formed by a winding line in which winding is repeated up until the BGA terminal, as in the first example embodiment.

In FIG. 8, the positive signal line section S1_{N} passes between through holes 42 of the BGA terminal, and extends along an imaginary straight line that is parallel to the fiber 20 of the glass cloth. One end of the positive signal line section S1_{N} and a signal through hole 40 of the BGA terminal (or the terminal itself) are connected to each other in a straight line. The line length L_{N} of the positive signal line section S1_{N} is a length that reaches the positive signal line section S1_{N-1} described later. The positive signal line section S1_{N-1} is in a position separate from a narrow region immediately below the LSI, separate by ½ of the glass cloth interval Pg₁ from the imaginary straight line on which the positive signal line section S1_{N} extends, and extends along the imaginary straight line that is parallel to the positive signal line section S1_{N}. The positive signal line section S1_{N} and the positive signal line section S1_{N-1} are connected to each other by a straight line.

Similarly, the negative signal line section S1′_{N′} passes between the through holes 42 of the BGA terminal, and extends along an imaginary straight line that is parallel to the positive signal line section S1_{N′}. One end of the negative signal line section S1′_{N′} and a signal through hole 41 are connected by a straight line. The line length L′_{N′} of the negative signal line section is a length that reaches the negative signal line section S1′_{N′-1}. The negative signal line section is in a position separate from a narrow region immediately below the LSI, separate by Pg₁/2 from the imaginary straight line on which the negative signal line section S1′_{N′} extends, and extends along the imaginary straight line that is parallel to the negative signal line section S1′_{N′}.

The positive signal line 10 and the negative signal line 11 respectively extend along an imaginary straight line separate by ½ of the glass cloth interval Pg₁ in the odd-numbered line section and the even-numbered line section. A total line length of the positive signal line section S1₂ᵢ₋₁ and a total line length of the positive signal line section S1₂ᵢ are equal to each other, and a total line length of the negative signal line section S1′₂ᵢ₋₁ and a total line length of the negative signal line section S1′₂ᵢ are equal to each other. Furthermore, a total line length of the positive signal line sections S1₂ᵢ₋₁ and S1₂ᵢ of the positive signal line 10 and are a total line length of the negative signal line sections S1′₂ᵢ₋₁ and S1′₂ᵢ of the negative signal line 11 are equal to each other. For this reason, an effect of the difference in permittivity between the resin 23 and the fiber 20 in the transmission line 12 on the propagation delay is small, due to the symmetry and periodicity of the volume ratio of the fiber 20 with respect to the resin 23.

According to a configuration in this second example embodiment, the transmission line 12 can be wired as a straight line, between the through holes of the BGA terminal. For this reason, even in a BGA terminal of 1 mm grid, which makes the wiring region of 0.3 mm, the positive signal line and the negative signal line of a wiring width of 1 mm can be wired.

### Third Example Embodiment

In examples of the first and second example embodiments, the invention according to the present application is applied to the entire transmission line. However, the invention according to the present applicant may be applied to a partial section of the transmission line, and a conventional technology may be applied to the remaining sections. The following explains a third example embodiment in which the invention according to the present application is applied to a partial section of the transmission line.

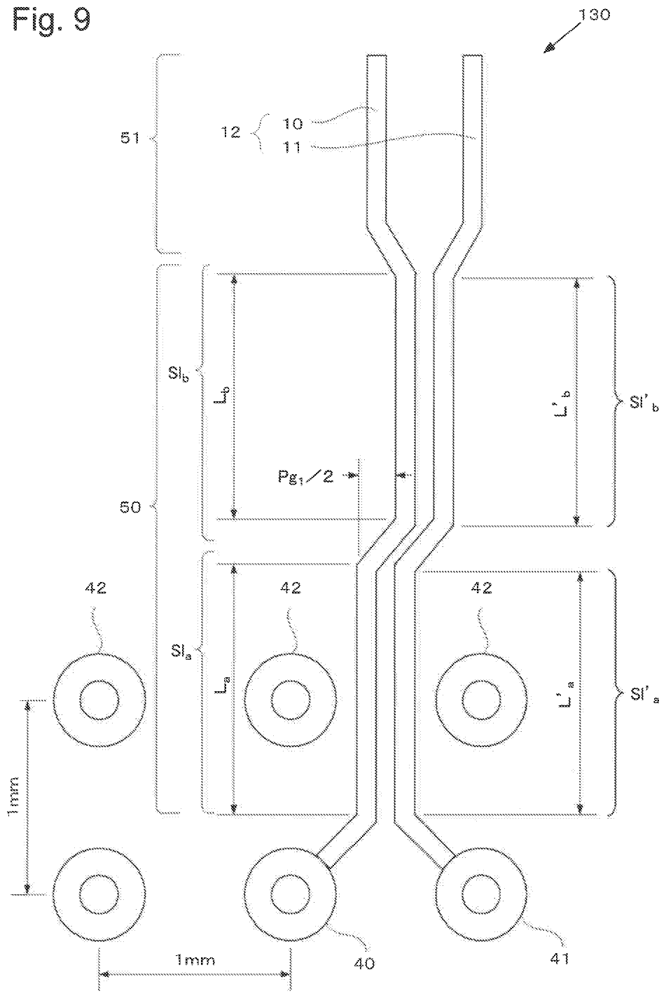

As illustrated in FIG. 9, the printed wiring board 130 according to an example embodiment of the present invention is wiring to which a conventional technology is applied to a wiring section S1 that is separate from a region immediately below the LSI.

In a wiring section 50 in a vicinity of the region immediately below the LSI, a positive signal line section S1ₐ passes between through holes 42, and extends along an imaginary straight line that is parallel to the fiber 20 of the glass cloth. One end of the positive signal line section S1ₐ and a signal through hole 40 of the BGA terminal are connected to each other in a straight line. The line length Lₐ of the positive signal line section S1ₐ is a length that reaches the positive signal line section S1_{b} described later. The positive signal line section S1_{b} is in a position separate from a narrow region immediately below the LSI, separate by ½ of the glass cloth interval Pg₁ from the imaginary straight line on which the positive signal line section S1ₐ extends, and extends along the imaginary straight line that is parallel to the positive signal line section S1ₐ. The positive signal line section S1ₐ and the positive signal section S1_{b} are connected to each other by a straight line. The positive signal line section S1_{b} and the positive signal line 10 of the wiring section S1 are also connected to each other by a line.

Similarly, the negative signal line section S1′ₐ passes between the through holes 42, and extends along an imaginary straight line that is parallel to the positive signal line section S1′ₐ. One end of the negative signal line section S1′_{a′} and a signal through hole 41 are connected by a straight line. The line length L′ₐ of the negative signal line section S1′ₐ is a length that reaches the negative signal line section S1′_{b}. The negative signal line section S1′_{b} is in a position separate from a narrow region immediately below the LSI, separate by Pg₁/2 from the imaginary straight line on which the negative signal line section S1′ₐ extends, and extends along the imaginary straight line that is parallel to the negative signal line section S1′ₐ. The negative signal line section S1′_{b} and the negative signal line 11 of the wiring section S1 are also connected to each other by a line.

The line length Lₐ and the line length L_{b} of the positive signal line 10 are equal to each other. Similarly, the line length L′ₐ and the line length L′_{b} of the negative signal line 11 are equal to each other. In addition, a total line length Lₐ+L_{b} of the positive signal line section S1ₐ and the positive signal line section S1_{b} is equal to a total line length L′ₐ+L′_{b} of the negative signal line section S1′ₐ and the negative signal line section S1′_{b}. Furthermore, an overall length of the positive signal line and an overall length of the negative signal line of the wiring section 50 are equal to each other.

The positive signal line section S1ₐ and the positive signal line section S1_{b} respectively extend along an imaginary straight line separate by ½ of the glass cloth interval Pg₁; whereas the negative signal line section S1′ₐ and the negative signal line section S1′_{b} extend along an imaginary straight line separate by ½ of Pg₁. For this reason, within the section 50, an effect of the difference in permittivity between the resin 23 and the fiber 20 in the transmission line 12 on the propagation delay is small, due to the symmetry and periodicity of the volume ratio of the fiber 20 with respect to the resin 23.

In addition, the transmission line 12 in wiring section S1 is subject to a smaller differential skew than in conventional technologies. Therefore, in the entire wiring sections 50 and 51, an effect of the difference in permittivity between the resin 23 and the fiber 20 in the transmission line 12 on the propagation delay is small.

### Fourth Example Embodiment

In examples of the first to third example embodiments, the interval between the imaginary straight line on which the odd-numbered positive signal line section S1₂ᵢ₋₁ extends and the imaginary straight line on which the even-numbered positive signal line section S1₂ᵢ extends is Pg₁/2; however, the interval may be Pg₁(n+½), where “n” is a natural number.

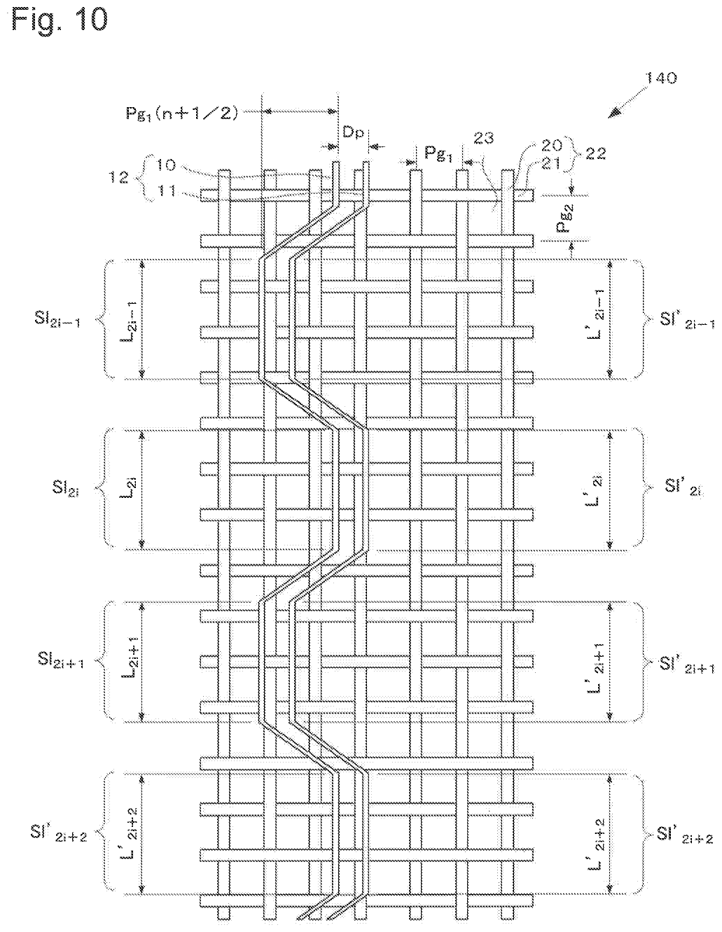

As illustrated in FIG. 10, on a printed wiring board 140 according to fourth example embodiment of the present invention, a distance between an imaginary straight line on which an odd-numbered positive signal line section S1₂ᵢ₋₁ extends and an imaginary straight line on which an even-numbered positive signal line section S1₂ᵢ extends is Pg₁(n+½). Similarly, a distance between an imaginary straight line on which an odd-numbered negative signal line section S1′₂ᵢ₋₁ extends and an imaginary straight line on which an even-numbered negative signal line section S1′₂, extends is Pg₁(n+½).

The positive signal line section S1₂ᵢ₋₁ and the positive signal line section S1₂ᵢ extend along imaginary straight lines separate from each other by Pg₁(n+½); and the negative signal line section S1′₂ᵢ₋₁ and the negative signal line section S1₂ᵢ extend along imaginary straight lines separate from each other by Pg₁(n+½).

Here, due to the symmetry and periodicity of the volume ratio of the fiber 20 with respect to the resin 23, the volume ratio of the fiber 20 with respect to the resin 23 is substantially the same, between at a position separate by Pg₁/2 which is ½ of the period, and at a position separate by Pg₁(n+½) which results from adding Pg₁/2 (½ of the period) to “n” multiple of Pg₁ (natural number multiple of the period).

For this reason, an effect of the difference in permittivity between the resin 23 and the fiber 20 in the transmission line 12 on the propagation delay is small.

### Fifth Example Embodiment

In examples of the first to fourth example embodiments, the odd-numbered positive signal line section S1₂ᵢ₋₁ and the even-numbered positive signal line section S1₂ᵢ are respectively on a same imaginary straight line. However, an example is also possible in which the positive signal line section S1₂ᵢ₋₁ extends along a plurality of parallel imaginary straight lines with a glass cloth interval Pg₁, and the positive signal line section S1₂ᵢ may extends along a plurality of imaginary straight lines, which are separate from the imaginary straight lines on which the positive signal line section S1₂ᵢ₋₁ extends by Pg₁(n₂ᵢ+½) and parallel to the positive signal line section S1₂ᵢ₋₁. That is, the imaginary straight lines along which the positive signal line section S1₂ᵢ extends are also a plurality of parallel imaginary straight lines aligned with an interval Pg₁. Here, “n₂ᵢ” is an integer equal to or more than 0, corresponding to the even-numbered section S1₂ᵢ.

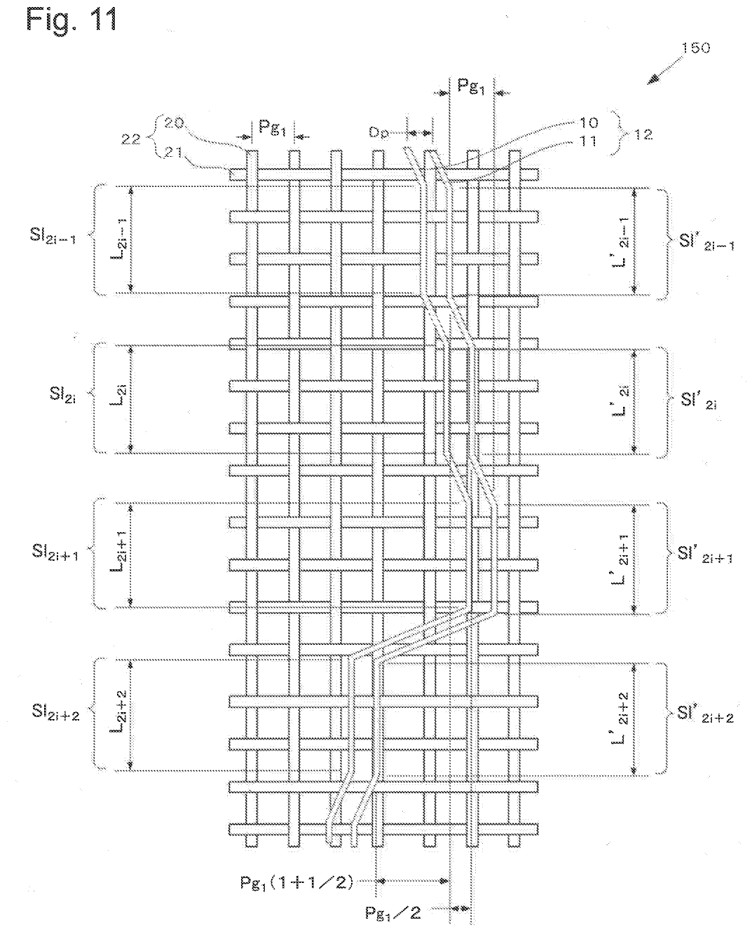

As illustrated in FIG. 11, on the printed wiring board 150 according to fifth example embodiment of the present invention, an interval between the imaginary straight line on which the odd-numbered positive signal line section S1₂ᵢ₋₁ extends and the imaginary straight line on which the positive signal line section S1₂ᵢ₊₁ extends is a glass cloth interval Pg₁.

On the other hand, a distance between the imaginary straight line along which the even-numbered positive signal line section S1₂ᵢ extends and the imaginary straight line along which the odd-numbered positive signal line section S1₂ᵢ₋₁ extends is Pg₁/2. A distance between the imaginary straight line on which the positive signal line section S1₂ᵢ+2 extends and the imaginary straight line on which the positive signal line section S1₂ᵢ₋₁ extends is Pg₁(1+½).

Similarly, on the negative signal line 11, too, a distance between the imaginary straight line along which the odd-numbered negative signal line section S1′₂ᵢ₋₁ extends and the imaginary straight line along which the negative signal line section S1′₂ᵢ₊₁ extends is Pg₁.

On the other hand, a distance between the imaginary straight line along which the even-numbered negative signal line section S1′₂ᵢ extends and the imaginary straight line along which the odd-numbered negative signal line section S1′₂ᵢ₋₁ extends is Pg₁/2. A distance between the imaginary straight line along which the negative signal line section S1′₂ᵢ₊₂ extends and the imaginary straight line along which the negative signal line section S1′₂ᵢ₋₁ extends is Pg₁(1+½).

Here, due to the symmetry and periodicity of the volume ratio of the fiber 20 with respect to the resin 23, the volume ratios of the fiber 20 with respect to the resin 23 are substantially equal to each other, at two positions separate by an integer multiple of 0 or more of its period, i.e. Pg₁. In addition, the volume ratios of the fiber 20 with respect to the resin 23 are substantially equal to each other, between at a position separate by ½ of the period, which is Pg₁/2, and at a position separate by a distance resulting from adding ½ of the period to n₂ᵢ-multiple of the distance Pg₁ (the period), which is Pg₁(n₂ᵢ+½).

For this reason, an effect of the difference in permittivity between the resin 23 and the fiber 20 in the transmission line 12 on the propagation delay is small, due to the symmetry and periodicity of the volume ratio of the fiber 20 with respect to the resin 23.

### Sixth Example Embodiment

In an example of the fifth example embodiment, the even-numbered positive signal line section extends along mutually parallel imaginary straight lines aligned with an interval of Pg₁ therebetween; and the odd-numbered positive signal line section extends along imaginary straight lines between these imaginary straight lines. However, the even-numbered positive signal line section and the odd-numbered positive signal line section do not have to on alternating imaginary straight lines.

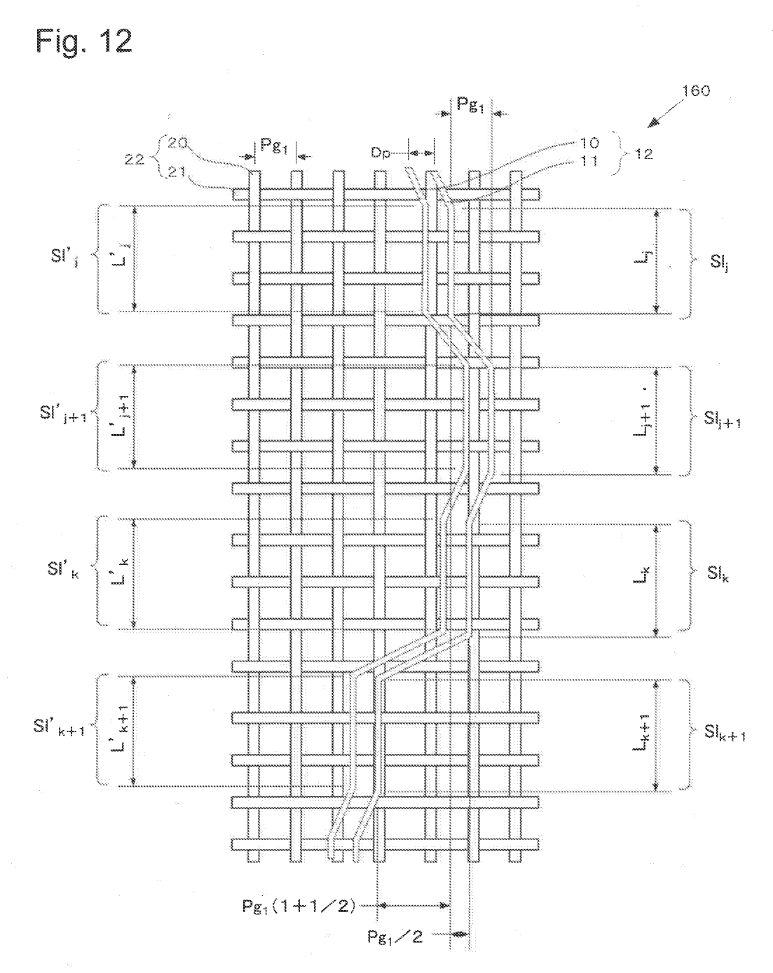

As illustrated in FIG. 12, on the printed wiring board 160 according to the sixth example embodiment of the present invention, a distance between an imaginary straight line on which the positive signal line section S1ⱼ extends and an imaginary straight line on which the positive signal line section S1ⱼ₊₁ extends is a glass cloth interval Pg₁. Note that “j” is an order of the positive signal lines sections extending on mutually parallel imaginary straight lines, with an interval Pg₁ therebetween.

A distance between an imaginary straight line on which the positive signal line section S1ⱼ extends and an imaginary straight line on which the positive signal line section S1ₖ extends is Pg₁/2. A distance between an imaginary straight line on which the positive signal line section S1ⱼ extends and an imaginary straight line on which the positive signal line section S1ₖ₊₁ extends is Pg₁(1+½). Note that “k” is an order of the positive signal line section which is separate by Pg₁(nₖ+½) from the imaginary straight line on which the positive signal line section S1ⱼ extends, and is parallel to the positive signal line section S1ⱼ extending along the imaginary straight line that is parallel to the positive signal line section S1ⱼ. “nₖ” is an integer equal to or more than 0, in accordance with the section S1ₖ.

Similarly, a distance between an imaginary straight line on which the negative signal line section S1′ⱼ extends and an imaginary straight line on which the negative signal line section S1′ⱼ₊₁ extends is Pg₁.

A distance between an imaginary straight line on which the negative signal line section S1′ⱼ extends and an imaginary straight line on which the negative signal line section S1′ₖ extends is Pg₁/2. A distance between an imaginary straight line on which the negative signal line section S1′ⱼ extends and an imaginary straight line on which the negative signal line section S1′ₖ₊₁ extends is Pg₁(1+½).

In addition, a total line length of the positive signal line section S1ⱼ and a total line length of the positive signal line section S1ₖ are equal to each other. A total line length of the negative signal line section S1′ⱼ and a total line length of the negative signal line section S1′ₖ are equal to each other. A total line length of the positive signal line sections S1ⱼ and S1ₖ and a total line length of the negative signal line sections S1′ⱼ and S1′ₖ are equal to each other. Moreover, an overall length of the positive signal line 10 and an overall length of the negative signal line 11 are equal to each other.

Here, due to the symmetry and periodicity of the volume ratio of the fiber 20 with respect to the resin 23, the volume ratios of the fiber 20 with respect to the resin 23 are substantially equal to each other, at two positions separate by an integer multiple of 0 or more of its period, i.e. Pg₁. In addition, the volume ratios of the fiber 20 with respect to the resin 23 are substantially equal to each other, between at a position separate by ½ of the period, which is Pg₁/2, and at a position separate by a distance resulting from adding ½ of the period to nₖ-multiple of the distance Pg₁ (the period), which is Pg₁(nₖ+½).

For this reason, an effect of the difference in permittivity between the resin 23 and the fiber 20 in the transmission line 12 on the propagation delay is small, due to the symmetry and periodicity of the volume ratio of the fiber 20 with respect to the resin 23.

### Seventh Example Embodiment

In examples of the first to sixth example embodiments, the transmission line 12 has a positive signal line 10 and a negative signal line 11 that are parallel to each other. However, the sections of the transmission line 12 may be partially not parallel.

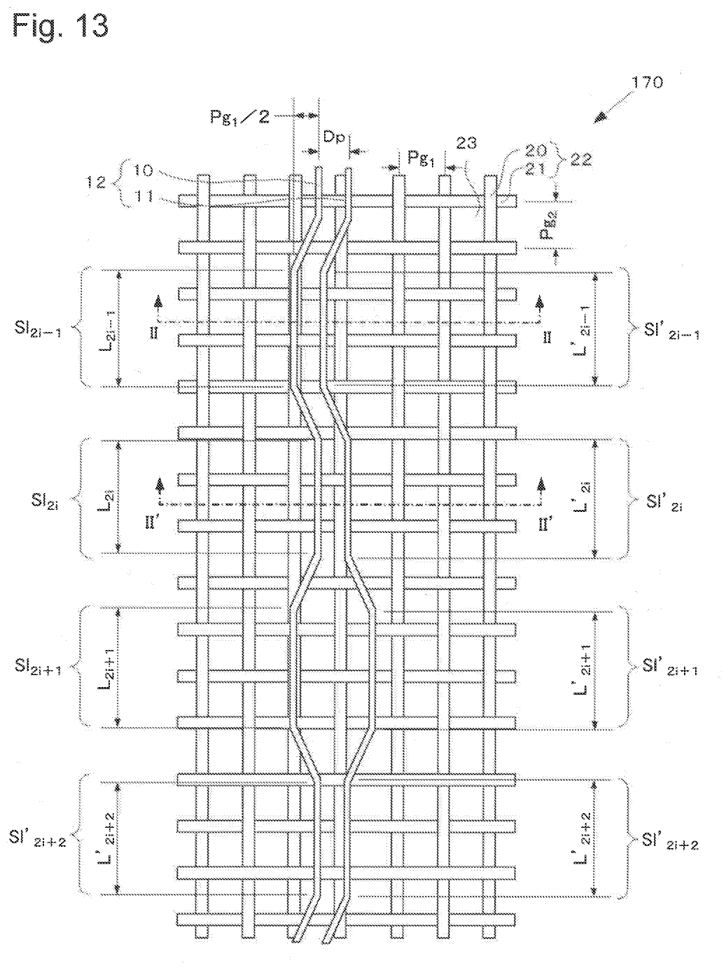

As illustrated in FIG. 13, on the printed wiring board 170 according to seventh example embodiment of the present invention, the positive signal line section S1₂ᵢ₊₁ extends along an imaginary straight line that is separate by Pg₁/2 from an imaginary straight line on which the positive signal line section S1₂ᵢ extends. The negative signal line section S1′₂ᵢ₊₁ extends along an imaginary straight line that is separate by Pg₁/2 from an imaginary straight line on which the negative signal line section S1′₂ᵢ extends. Here, a direction from the positive signal line section S1₂ᵢ to the positive signal line section S1₂ᵢ₊₁ is reverse to a direction from the negative signal line section S1′₂ᵢ to the negative signal line section S1′₂ᵢ₊₁. That is, a distance between the positive signal line section S1₂ᵢ₊₁ and the negative signal line section S1′₂₊₁ is larger, by Pg₁, than a distance between the positive signal line section S1₂ᵢ and the negative signal line section S1′₂ᵢ.

Here, a distance between an imaginary straight line on which the odd-numbered negative signal line section S1′₂ᵢ₋₁ extends and an imaginary straight line on which the odd-numbered negative signal line section S1′₂ᵢ₊₁ extends is Pg₁. Here, due to the symmetry and periodicity of the volume ratio of the fiber 20 with respect to the resin 23, the volume ratios of the fiber 20 with respect to the resin 23 are substantially equal to each other, at two positions separate by its period, i.e. Pg₁.

For this reason, an effect of the difference in permittivity between the resin 23 and the fiber 20 in the transmission line 12 on the propagation delay is small, due to the symmetry and periodicity of the volume ratio of the fiber 20 with respect to the resin 23.

The seventh example embodiment is not limited to the configuration described above, and can be combined with the configuration of the sixth example embodiment. The positive signal line section S1ⱼ extends along a plurality of mutually parallel imaginary straight lines which are aligned with a glass cloth interval Pg₁ therebetween, and the positive signal line section S1ₖ extends along a plurality of mutually parallel imaginary straight lines which are separate by Pg₁(nₖ+½) from the imaginary straight lines on which the positive signal line section S1ⱼ extends and are parallel to the positive signal line section S1ⱼ. Similarly, in the case of negative signal lines, the negative signal line section S1′ⱼ extends along a plurality of mutually parallel imaginary straight lines which are aligned with a glass cloth interval Pg₁ therebetween, and the negative signal line section S1′ₖ extends along a plurality of mutually parallel imaginary straight lines which are separate by Pg₁(n′ₖ+½) from the imaginary straight lines on which the negative signal line section S1′ⱼ extends and are parallel to the negative signal line section S1′₃. Here, “nₖ” and “n′ₖ” are an integer equal to or more than 0, and they may not be equal to each other.

So far, example embodiments of the present invention have been explained, which do not limit the present invention.

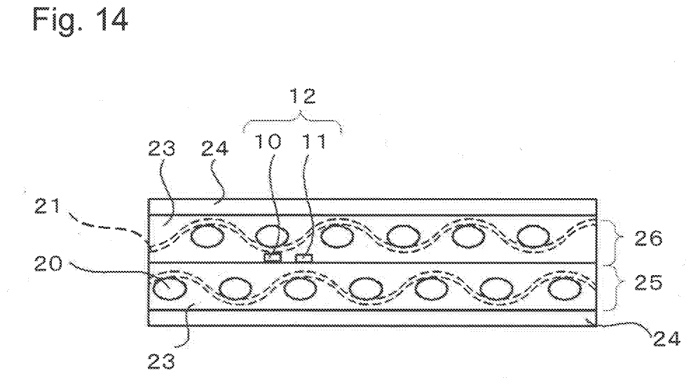

For example, as an example of placing the fibers 20 configuring the insulation layers 25 and 26, to be parallel to each other, a configuration has been exemplified, in which a position of the fibers 20 configuring the insulation layer 26 is located above the fibers 20 configuring the insulation layer 25. However, as illustrated in FIG. 14, a position of the fibers 20 configuring the insulation layer 26 does not necessarily have to be located above the fibers 20 configuring the insulation layer 25.

In addition, in the above-described example embodiments, the line width of the positive signal line 10 and the negative signal line 11 is exemplified as 0.1 to 0.2 mm. However, any line width may be adopted.

In addition, in the above-described embodiments, the interval Dp between the positive signal line 10 and the negative signal line 11 is exemplified as satisfying Dp<Pg₁, however may be Dp≥Pg₁. From the viewpoint of the differential skew, the relation Dp=Pg₁/2 is desirable.

In addition, in the above-described embodiments, a strip line is exemplified as the transmission line. However, this is not limiting, and the transmission line may be micro strip line or a co-planer line. A micro strip line includes an insulation layer 25, a ground layer 24 that is in contact with the insulation layer 25, and a transmission line 12, instead of including an insulation layer 26 and a ground layer 24 that is in contact with the insulation layer 26. In addition, a co-planer line includes an insulation layer 25, a transmission line 12, and a ground by way of conductors such as copper foil at a certain interval therebetween, and aligned outside of and to the left and right of the transmission line 12, sandwiching the transmission line 12 therebetween.

In addition, in the above-described example embodiment, a single-layer printed wiring board is exemplified as the printed wiring board. However, a multilayer circuit board may be adopted, which is formed by layering single-layer printed wiring boards.

In addition, in the determining method of a wiring pattern, having been described above, the angle θ was exemplified as an angle formed between the positive signal line section S1ᵢ and the line 10c. However, the angle θ may be an angle formed between the fiber 20 and the line 10c.

In addition, in the determining method of a wiring pattern, having been described above, as an instructing unit to instruct the glass cloth interval Pg, the interval Dp between the positive signal line and the negative signal line, the maximum value L^{max} of the line length Lᵢ of the positive signal line section, and the angle θ, inputting through the operating unit 201 has been exemplified. However, a configuration is also possible in which they are accumulated in the auxiliary storage unit 204 in advance, and are read by the controller 202 where necessary at the execution of a program.

In addition, in the determining method of a wiring pattern, having been described above, the maximum value L^{max} of the line length of Lᵢ of the positive signal line section is exemplified to be input. However, a configuration is also possible in which the minimum value L^{min} or a rough line length L^{req} is input. When inputting the minimum value L^{min}, the conditions of L₂ᵢ₋₁≤L^{max} and L₂ᵢ≤L^{max} are changed to the conditions of L₂ᵢ₋₁≥L^{min} and L₂≥L^{min}. In addition, when inputting the line length L^{req}, the conditions of L₂ᵢ₋₁≤L^{max} and L₂ᵢ≤L^{max} are changed to the condition to select values of L₂ᵢ₋₁ and L₂ᵢ, to be closest to the line length L^{req}.

So far, some example embodiments and their modification examples according to the invention according to the present application have been described. However, the printed wiring board according to the invention according to the present application does not have to include all the exemplified configurations.

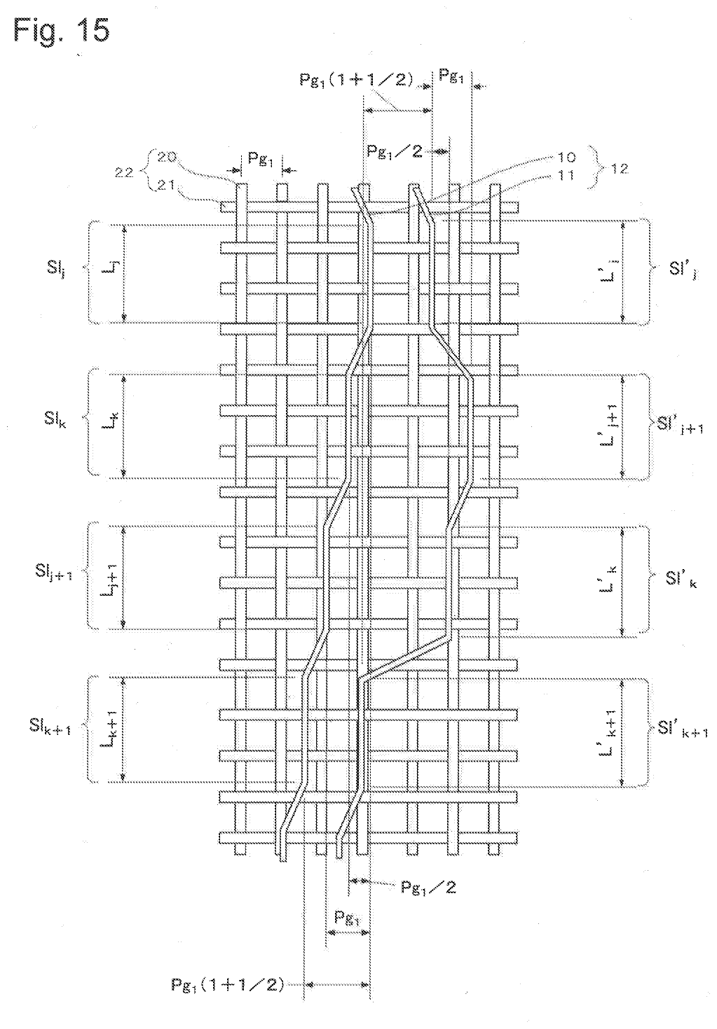

For example, the printed wiring board illustrated in FIG. 15 may be achieved by a configuration that includes:

an insulation layer configured by a glass cloth 22 in which the fibers 20 and 21 are woven, and a resin with which the glass cloth 22 is impregnated;

a positive signal line 10 which is first wiring and is configured by
a line in a positive signal line section S1ⱼ, which is a first line extending on an imaginary straight line that is parallel to the fiber 20 woven into the glass cloth 22,
a line in a positive signal line section S1ₖ that is a second line extending on an imaginary straight line that is parallel to a line in the positive signal line section S1ⱼ, which is separate from an imaginary straight line on which the positive signal line section S1ⱼ extends, by a distance resulting from adding ½ of the interval Pg₁ of the fiber 20 to an integer multiple equal to 0 or more of the interval of the fiber 20, and
a third line connecting a line in the positive signal line section S1ⱼ and a line in the positive signal line section S1ₖ; and

a negative signal line 11 which is second wiring and is configured by
a line in a negative signal line section S1′ⱼ extending on an imaginary straight line that is parallel to a line of the positive signal line section S1ⱼ,
a negative signal line section S1′ₖ that is a fifth line extending on an imaginary straight line that is parallel to a line in the negative signal line section S1′ⱼ, which is separate from an imaginary straight line on which the negative signal line section S1′ⱼ extends, by a distance resulting from adding ½ of the interval of the fiber to an integer multiple equal to 0 or more of the interval Pg₁ of the fiber 20, and
a sixth line that connects between lines configuring a line in the negative signal line section S1′ⱼ and a line in the negative signal line section S1′ₖ, where

a total line length of the line in the positive signal line section S1ⱼ and a total line length of the line in the positive signal line section S1ₖ are equal to each other,

a total line length of the line in the negative signal line section S1′ⱼ and a total line length of the line in the negative signal line section S1′ₖ are equal to each other,

a total line length of the line in the negative signal line section S1′ⱼ and the line in the negative signal line section S1′ₖ and a total line length of the line in the positive signal line section S1ⱼ and the line in the positive signal line section S1ₖ are equal to each other, and

a line length of the positive signal line 10 and a line length of the negative signal line 10 are equal to each other.

Note that the positive signal line 10 and the negative signal line 11 are disposed on the insulation layer. In addition, any polarity of a signal may be adopted, which may be reversed.

Note that a part or all of the example embodiments described above can also be expressed as in the following Supplementary notes; however, the present invention exemplified in the above example embodiments is not limited to the following Supplementary notes.

### (Supplementary Note 1)

A printed wiring board characterized by comprising:

an insulation layer configured by a glass cloth in which fiber is woven, and a resin with which the glass cloth is impregnated;

first wiring configured by
a first line extending on an imaginary straight line that is parallel to the fiber woven in the glass cloth,
a second line extending on an imaginary straight line that is parallel to the first line, the second line being separate from the imaginary straight line on which the first line extends, by a distance resulting from adding ½ of an interval of the fiber to an integer multiple equal to 0 or more of the interval of the fiber, and
a third line connecting lines configuring the first line and the second line; and

second wiring configuring by
a fourth line extending on an imaginary straight line that is parallel to the first line,
a fifth line on an imaginary straight line that is parallel to the fourth line, the fifth line being separate from the imaginary straight line on which the fourth line extends, by a distance resulting from adding ½ of an interval of the fiber to an integer multiple equal to 0 or more of the interval of the fiber, and
a sixth line connecting lines configuring the fourth line and the fifth line, wherein

a total line length of the first line and a total line length of the second line are equal to each other,

a total line length of the fifth line and a total line length of the sixth line are equal to each other,

a total line length of the fourth line and the fifth line and are a total line length of the first line and the second line are equal to each other, and

a line length of the first wiring and a line length of the second wiring are equal to each other.

### (Supplementary Note 2)

The printed wiring board according to Supplementary note 1, characterized in that

the first line extends along mutually equal imaginary straight lines, and

the fourth line extends along mutually equal imaginary straight lines,

### (Supplementary Note 3)

The printed wiring board according to Supplementary note 1 or 2, characterized in that

the first line extends along mutually equal imaginary straight lines,

the second line extends along mutually equal imaginary straight lines,

the fourth line extends along mutually equal imaginary straight lines, and

the fifth line extends along mutually equal imaginary straight lines.

### (Supplementary Note 4)

The printed wiring board according to any one of Supplementary notes 1 to 3, characterized in that

the third line is configured by a line whose one end is connected to the first line, the other end thereof being connected to the second line, and

the sixth line is configured by a line whose one end is connected to the fourth line, the other end thereof being connected to the fifth line.

### (Supplementary Note 5)

The printed wiring board according to any one of Supplementary notes 1 to 4, characterized in that

the third line is formed of a straight line, and

the sixth line is formed of a straight line.

### (Supplementary Note 6)

The printed wiring board according to any one of Supplementary notes 1 to 5, characterized in that

the third line is formed of a straight line,

an angle θ formed between the third line and the first line is 0<θ<90°,

the sixth line is formed of a straight line, and

an angle θ formed between the sixth line and the fourth line is 0<θ<90°.

### (Supplementary Note 7)

The printed wiring board according to any one of Supplementary notes 1 to 6, characterized in that

the first wiring and the second wiring are configured by lines that are parallel to each other.

### (Supplementary Note 8)

The printed wiring board according to Supplementary note 7, characterized in that

an interval between the first wiring and the second wiring is configured shorter than the interval of the fiber.

### (Supplementary Note 9)

The printed wiring board according to any one of Supplementary notes 1 to 8, characterized in that

an interval between the first wiring and the second wiring is equal to ½ of the interval of the fiber.

### (Supplementary Note 10)

An electronic circuit characterized by comprising a printed wiring board according to any one of Supplementary notes 1 to 9.

### (Supplementary Note 11)

A determining method of wiring of a printed wiring board according to any one of Supplementary notes 1 to 9, characterized by comprising:

a step of extracting, by a controller, a transmission line that is parallel to the fiber, from among a plurality of transmission lines configuring a wiring pattern;

a step of designating, by a designating unit, an angle formed between the fiber and the third line;

a step of calculating, by the controller, a line length of the third line and a length of a component of the third line that is parallel to the fiber, under a condition that i) a length resulting from adding ½ of the interval of the fiber to an integer multiple equal to 0 or more of the interval of the fiber is equal to a length of a component of the third line that is orthogonal o the fiber, and ii) the angle designated by the designating unit;

a step of calculating, by the controller, a line length of the first line and a line length of the second line, under a condition that i) a line length of the first line is equal to a line length of the second line, ii) a total length of a length of a component of the third line that is parallel to the fiber, the line length of the first line, and the line length of the second line is equal to a line length of the transmission line;

a step of determining, by the controller, the first wiring configured by the first line, the second line, and the third line, under a condition that i) the first line is configured by a line that is parallel to the fiber, ii) the second line is configured by a line that is parallel to the first line, and iii) a distance between an imaginary straight line that is an extension of the first line and the second line is configured by a length of a component of the third line that is orthogonal to the fiber, and iv) the angle is equal to an angle formed between the imaginary straight line that is an extension of the first line and the third line; and

a step of determining the second wiring by the controller, under a condition that i) the second wiring is configured by a line that is parallel to the first wiring, ii) a line length of the second wiring is equal to a line length of the first wiring.

### (Supplementary Note 12)

A program for executing a method according to Supplementary note 11.

So far, the present invention has been explained by way of the above-described exemplary embodiments. However, the present invention is not limited to the above-described example embodiments. In other words, the present invention can be applied to various modes which a person skilled in the art can conceive of, within the scope of the present invention.

This application is based upon and claims the benefit of priority from Japanese patent application No. 2006-56292, filed on Mar. 18, 2016, the disclosure of which is incorporated herein in its entirety by reference.

### REFERENCE SIGNS LIST

10 positive signal line
11 negative signal line
12 transmission line
20 fiber
21 fiber
22 glass cloth
23 resin
24 ground layer
25 insulation layer
26 insulation layer
31 position at which volume ratio of fiber with respect to resin is high
32 position separated from position 31 by Pg₁/2
33 position at which volume ratio of fiber with respect to resin is medium
34 position separate from position 33 by Pg₁/2
35 position at which volume ratio of fiber with respect to resin is low
36 position separate from position 35 by Pg₁/2
37a one end of positive signal line section S1₁
37b position at which positive signal line section S1₁ and line 10c are connected
38a position at which positive signal line section S1₂ and line 10c are connected
38b position at which positive signal line section S1₂ and line 10d are connected
39a position at which positive signal line section S1ⱼ and line 10d are connected
40 signal through hole
41 signal through hole
42 through hole
50 wiring section in vicinity of region immediately below LSI
51 wiring section separate from region immediately below LSI
110 printed wiring board according to first example embodiment of the present invention
120 printed wiring board according to second example embodiment of the present invention
130 printed wiring board according to third example embodiment of the present invention
140 printed wiring board according to fourth example embodiment of the present invention
150 printed wiring board according to fifth example embodiment of the present invention
160 printed wiring board according to according to sixth example embodiment of the present invention
170 printed wiring board according to according to seventh example embodiment of the present invention
200 processor
201 operating unit
202 controller
203 main storage unit
204 auxiliary storage unit
205 display

What is claimed is:

1. A printed wiring board comprising:
an insulation layer configured by a glass cloth in which fiber is woven, and a resin with which the glass cloth is impregnated;
first wiring configured by
a first line extending on an imaginary straight line that is parallel to the fiber woven in the glass cloth,
a second line extending on an imaginary straight line that is parallel to the first line, the second line being separate from the imaginary straight line on which the first line extends, by a distance resulting from adding ½ of an interval of the fiber to an integer multiple equal to 0 or more of the interval of the fiber, and
a third line connecting lines configuring the first line and the second line; and
second wiring configuring by
a fourth line extending on an imaginary straight line that is parallel to the first line,
a fifth line on an imaginary straight line that is parallel to the fourth line, the fifth line being separate from the imaginary straight line on which the fourth line extends, by a distance resulting from adding ½ of an interval of the fiber to an integer multiple equal to 0 or more of the interval of the fiber, and
a sixth line connecting lines configuring the fourth line and the fifth line, wherein
a total line length of the first line and a total line length of the second line are equal to each other,
a total line length of the fifth line and a total line length of the sixth line are equal to each other,
a total line length of the fourth line and the fifth line and a total line length of the first line and the second line are equal to each other, and
a line length of the first wiring and a line length of the second wiring are equal to each other.

2. The printed wiring board according to claim 1, wherein
the first line extends along mutually equal imaginary straight lines, and
the fourth line extends along mutually equal imaginary straight lines.

3. The printed wiring board according to claim 1, wherein
the first line extends along mutually equal imaginary straight lines,
the second line extends along mutually equal imaginary straight lines,
the fourth line extends along mutually equal imaginary straight lines, and
the fifth line extends along mutually equal imaginary straight lines.

4. The printed wiring board according to claim 1, wherein
the third line is configured by a line whose one end is connected to the first line, the other end thereof being connected to the second line, and
the sixth line is configured by a line whose one end is connected to the fourth line, the other end thereof being connected to the fifth line.

5. The printed wiring board according to claim 1, wherein
the third line is formed of a straight line, and
the sixth line is formed of a straight line.

6. The printed wiring board according to claim 1, wherein
the third line is formed of a straight line,
an angle θ formed between the third line and the first line is 0<θ<90°,
the sixth line is formed of a straight line, and
an angle θ formed between the sixth line and the fourth line is 0<θ<90°.

7. The printed wiring board according to claim 1, wherein
the first wiring and the second wiring are configured by lines that are parallel to each other.

8. The printed wiring board according to claim 7, wherein
an interval between the first wiring and the second wiring is configured shorter than the interval of the fiber.

9. The printed wiring board according to claim 1, wherein
an interval between the first wiring and the second wiring is equal to ½ of the interval of the fiber.

10. An electronic circuit comprising a printed wiring board according to claim 1.

11. A determining method of wiring of a printed wiring board according to claim 1, comprising:
extracting, by a controller, a transmission line that is parallel to the fiber, from among a plurality of transmission lines configuring a wiring pattern;
designating, by a designating unit, an angle formed between the fiber and the third line;
calculating, by the controller, a line length of the third line and a length of a component of the third line that is parallel to the fiber, under a condition that i) a length resulting from adding ½ of the interval of the fiber to an integer multiple equal to 0 or more of the interval of the fiber is equal to a length of a component of the third line that is orthogonal o the fiber, and ii) the angle designated by the designating unit;
calculating, by the controller, a line length of the first line and a line length of the second line, under a condition that i) a line length of the first line is equal to a line length of the second line, ii) a total length of a length of a component of the third line that is parallel to the fiber, the line length of the first line, and the line length of the second line is equal to a line length of the transmission line;
determining, by the controller, the first wiring configured by the first line, the second line, and the third line, under a condition that i) the first line is configured by a line that is parallel to the fiber, ii) the second line is configured by a line that is parallel to the first line, and iii) a distance between an imaginary straight line that is an extension of the first line and the second line is configured by a length of a component of the third line that is orthogonal to the fiber, and iv) the angle is equal to an angle formed between the imaginary straight line that is an extension of the first line and the third line; and
determining the second wiring by the controller, under a condition that i) the second wiring is configured by a line that is parallel to the first wiring, ii) a line length of the second wiring is equal to a line length of the first wiring.

12. A non-transitory computer-readable program recording medium for recording a program to determine wiring of a printed wiring board including:
an insulation layer configured by a glass cloth in which fiber is woven, and a resin with which the glass cloth is impregnated;
first wiring configured by
a first line extending on an imaginary straight line that is parallel to the fiber woven in the glass cloth,
a second line extending on an imaginary straight line that is parallel to the first line, the second line being separate from the imaginary straight line on which the first line extends, by a distance resulting from adding ½ of an interval of the fiber to an integer multiple equal to 0 or more of the interval of the fiber, and
a third line connecting lines configuring the first line and the second line; and
second wiring configuring by
a fourth line extending on an imaginary straight line that is parallel to the first line,
a fifth line on an imaginary straight line that is parallel to the fourth line, the fifth line being separate from the imaginary straight line on which the fourth line extends, by a distance resulting from adding ½ of an interval of the fiber to an integer multiple equal to 0 or more of the interval of the fiber, and
a sixth line connecting lines configuring the fourth line and the fifth line,
the program make a computer to execute:
an extracting process for extracting a transmission line that is parallel to the fiber, from among a plurality of transmission lines configuring a wiring pattern;
a designating process for designating an angle formed between the fiber and the third line;
a calculating process for calculating a line length of the third line and a length of a component of the third line that is parallel to the fiber, under a condition that i) a length resulting from adding ½ of the interval of the fiber to an integer multiple equal to 0 or more of the interval of the fiber is equal to a length of a component of the third line that is orthogonal o the fiber, and ii) the angle designated by the designating process;
a calculating process for calculating a line length of the first line and a line length of the second line, under a condition that i) a line length of the first line is equal to a line length of the second line, ii) a total length of a length of a component of the third line that is parallel to the fiber, the line length of the first line, and the line length of the second line is equal to a line length of the transmission line;
a determining process for determining the first wiring configured by the first line, the second line, and the third line, under a condition that i) the first line is configured by a line that is parallel to the fiber, ii) the second line is configured by a line that is parallel to the first line, and iii) a distance between an imaginary straight line that is an extension of the first line and the second line is configured by a length of a component of the third line that is orthogonal to the fiber, and iv) the angle is equal to an angle formed between the imaginary straight line that is an extension of the first line and the third line; and
a determining process of the second wiring, under a condition that i) the second wiring is configured by a line that is parallel to the first wiring, ii) a line length of the second wiring is equal to a line length of the first wiring.
